(19) United States
(12) Patent Application Publication
(10) Pub. No.: US 2007/0120698 A1
(43) Pub. Date: May 31, 2007

(54) System for monitoring the proximity of personal articles

(76) Inventors: Jordan Turk, Thornhill (CA); Trevor Park, Thornhill (CA)

Correspondence Address: BERESKIN AND PARR, 40 KING STREET WEST, BOX 401, TORONTO, ON, M5H 3Y2, CA

(21) Appl. No.: 11/288,206

(22) Filed: Nov. 29, 2005

(51) Int. Cl. G08B 21/00; G08B 1/08

(52) U.S. Cl. 340/686.6; 340/539.21

(57) ABSTRACT

A system and method for monitoring the proximity of personal articles. The system includes at least one wireless tracking device affixable to at least one portable article to be monitored, and two portable master wireless communication devices, a first master communication device that determines when the tracking device is outside of a first operating range, and a second master communication device that determines when the tracking device is outside a second operating range. The first master communication device and the second master communications devices are operable to communicate with each other to determine whether the first master communication device and the second master communication device are within a predetermined master range. At least one of the first master communication device and the second master communication device is operable to generate an alarm if the first master communications and the second master communication device are not within the predetermined master range. At least one of the first master communication device and the second master communication device is operable to generate an alarm if the least one tracking device is outside of the first operating range and the second operating range.

### FIELD OF THE INVENTION

The present invention relates to wireless systems for protecting personal articles against loss and theft.

### BACKGROUND OF THE INVENTION

People regularly carry personal articles, such as car keys, wallets, cell phones, personal music players and other portable hand-held electronic devices. Many of these articles are small and can easily be left behind or forgotten and become lost. A number of these articles are also common targets of theft, as they may have significant value, contain important information or documents, or have other value to a person. The high value of these articles generally means such that the loss of such articles is a serious concern for the person, and it is desirable to prevent these articles from being forgotten, misplaced and stolen.

Some systems exist for locating articles that have already been lost or misplaced. For example, Crabtree et al. (U.S. Pat. No. 6,788,199) discloses a system for locating objects using transceivers attached to objects to be tracked and a handheld portable locating unit, which is carried by a user. The locator communicates wirelessly with the transceivers, and the time taken for a signal to travel round trip from the locator to the transceivers is used to determine an approximate distance between the transceivers and the locating unit. Crabtree also discloses a system utilizing a first locator unit and a second locator unit, in which the first locator unit can locate a transceiver that is outside of its range, but that is within range of the second locator unit. The purpose of the Crabtree system is to allow a user to locate objects and to determine the distance and the bearing to objects that the user now wishes to locate.

Kreiner et al. (U.S. Pat. No. 6,900,731) describes a system for locating objects that are lost or misplaced. Monitors that are inductively coupled to passive tags attached to objects or articles to be tracked. The monitors and the tags pass identification signals back and forth. The monitors are in communication with at least one network, and preferably a number of networks. Kreiner discloses the use of multiple monitors wherein the monitors are connected via a network such as a cellular telephone network.

Koslar (U.S. Pat. No. 6,404,338) discloses a fixed measuring and security system for protecting an object using fixed transmission systems positioned at control points, wherein the transmission systems communicate with each other, and are adapted to trigger an alarm when a particular object moves outside of predetermined activity areas. This system is not readily adaptable to be used to protect against loss or theft of personal articles.

McCall et al. (U.S. Pat. No. 6,738,628) discloses a system for tracking objects within a building for inventory purposes by using an array of fixed transmitting beacons and a radio device associated with an object, such as a personal computer or server computer. Each beacon transmits identification data to the radio device, and may be associated with an existing wireless communication mechanism, such as a Bluetooth network.

Bero et al. (U.S. Pat. No. 6,563,427) describes a system of proximity monitoring using a wireless communication system operating on two wireless local area networks, such as cell phone networks. A wireless device, such as a cell phone, communicates with a tracking device attached to an object being tracked, and an alarm is triggered when the monitor is no longer within a predetermined range.

None of the aforesaid prior art systems provides a person with an optimized system and apparatus for protecting against the loss or theft of articles carried by the person. There is accordingly a need in the art for a solution that provides a user with a flexible and portable system to protect against the loss and theft of personal articles without requiring a high degree of user involvement.

### SUMMARY OF THE INVENTION

The present invention is directed to a system for monitoring the proximity of personal articles. The system comprises at least one wireless tracking device affixable to at least one portable article to be monitored, a first master wireless communication device for communicating with the at least one tracking device and for determining when the at least one tracking device is outside of a first operating range, and a second portable master wireless communication device for communicating with the at least one tracking device and for determining when the at least one tracking device is outside of a second operating range. The first master communication device and the second master communication device are operable to communicate with each other and to determine whether the first master communication device and the second master communication device are within a predetermined master range. At least one of the first master communication device and the second master communication device is operable to generate an alarm if the second master communications and the second master communication device are not within the predetermined master range. At least one of the first master communication device and the second master communication device is operable to generate an alarm if the least one tracking device is outside of the first operating range and the second operating range.

Another aspect of the present invention is a method for preventing the loss of portable personal articles. The method comprises the steps of:

(a) providing a user with a first portable master wireless communication device having a first operating range and a second portable master wireless communication device having a second operating range, the first master communication device and second master communication device being in wireless communication with each other;

(b) attaching at least one wireless tracking device to a portable personal article, the tracking device being in wireless communication with the first master communication device and the second master communications device;

(c) determining whether the first master communication device and the second master communication device are within a predetermined distance from each other and generating an alarm if the first master communication device and the second master communication device are not within the predetermined distance;

(d) sending a first locating signal from the first master communication device to the tracking device to determine a first distance between the first master communication device and the tracking device;

(e) generating an activation signal activating the second master communication device if the first distance is outside the first operating range;

(e) sending a second locating signal from the second master communication device to the tracking device to determine a second distance between the second master communication device and the tracking device; and

(f) generating an alarm if the second distance is outside the second operating range.

### BRIEF DESCRIPTION OF THE DRAWINGS

The invention will now be described, by way of example only, with reference to the following drawings, in which:

FIG. 1 is diagram of a system made in accordance with a preferred embodiment of the invention;

FIG. 2 is a perspective view of a first master wireless communication device of the system of the present invention, shown inserted into a wallet.

FIG. 3 is a perspective view of a second master wireless communication device of the system of the present invention, shown attached to a set of keys.

FIG. 4 is a block diagram of a wireless transceiver module and a passive ID tag of the present invention; and

FIG. 5 is a flowchart of a method for monitoring the proximity of personal articles, implemented by the system of the present invention.

### DETAILED DESCRIPTION OF THE INVENTION

The present invention is directed to a system and method for monitoring the proximity of personal articles, which provides a user with a wearable personal “force-field” that protects against the loss or theft of the personal articles.

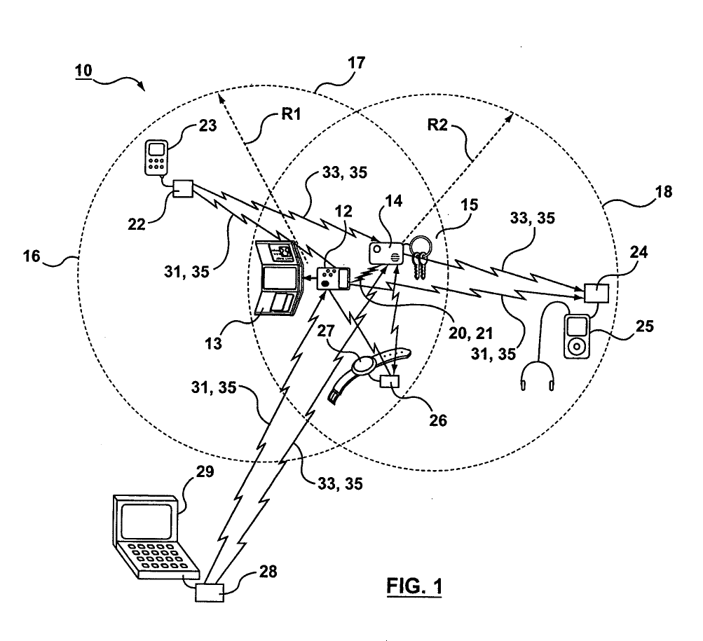

FIG. 1 shows a system 10 in accordance with a preferred embodiment of the present invention. System 10 comprises a first portable master wireless communication device 12, a second portable master wireless communication device 14, and a plurality of wireless tracking devices 22, 24, 26 and 28 attached to personal articles to be monitored. First master communication device 12 is sized and shaped to be small enough to be conveniently carried by a person, for example by inserting first master communication device 12 into a wallet 13 carried by the user. Second master communication device 14 is also sized and shaped to be carried by the person, and may be attached to a set of car keys 15, for example.

First master communication device 12 has a first operating range 16, which is of a generally spherical shape and which has a predetermined radius R1. Second master communication device 14 has a second operating range 18, which is also of a generally spherical shape and which as a predetermined radius of R2. R1 and R2 may be determined in any number of various different ways. For example, R1 and R2 may be selected by the user to accord with the user's personal preferences, or may be hardwired into first master communication device 12 and second master communication device 14, or may be based on the physical limitations of wireless transceiver technology on first master communication device 12 and second master communication device 14, or may be determined according to another criteria. In a preferred embodiment, R1 and R2 are of generally equal distance, and are preferably about 5-10 feet.

First master communication device 12 and second master communication device 14 communicate with each other using first command signals 20 sent from first master communication device 12 to second master communication device 14, and second command signals 21 sent from second master communication device 14 to first master communication device 12. First command signals 20 and second command signals 21 may comprise instructions between first and second master communication devices 12, 14 and are used to determine the distance between the first and second master communication devices 12, 14. If the distance indicates that the second master communication device 14 is not within a predetermined master range 17 of first master communication device 12, an alarm is activated on at least one of first and second master communications devices 12, 14. As shown, master range 17 is equal to first operating range 16.

The distance between master communication devices 12, 14 may be calculated using different methods. For example, it may be based on the strength of first command signal 20 received by second master communication device 14 or the strength of the second command signal 21 received by first master communication device 14. The distance may also be calculated by measuring the total round trip time taken for first command signal 20 to be sent from first master communication device 12 to second master communication device 14 and second command signal 21 sent back to first master communication device 12. Other methods for determining distance may be used as are known in the art.

During operation, first master communication device 12 and second master communication device 14 operate together to provide a protective “force-field” which includes the first operating range 16 plus the second operating range 18.

Wireless tracking devices 22, 24, 26 and 28 receive locating signals 31, 33 from first and second master communications devices 12, 14, respectively, and send return signals 35 to first and second master communication devices 12, 14, respectively. The return signal 35 of each wireless tracking device 22, 24, 26, and 28 contains a unique identification number, and each tracking device is affixed to a different personal article to be tracked. For example, first wireless tracking device 22 may be affixed to a cell phone 23, second wireless tracking device 24 may be affixed to a personal music player 25, third wireless tracking device 26 may be affixed to a watch 27, and fourth wireless tracking device 28 may be affixed to a laptop 29.

During operation, first master communication device 12 scans for all wireless tracking devices 22, 24, 26, and 28 that are associated with first master communication device 12 by sending locating signals 31 to and receiving return signals 35 from wireless tracking devices 22, 24, 26 and 28. In this example, first wireless tracking device 22 and third wireless tracking device 26 are both within first operating range 16, and thus would be quickly detected by first master communication device 12. However, second wireless tracking device 24 and fourth wireless tracking device 28 are outside of first operating range 16. First master communication device 12 then sends command signal 20 to second master communication device 14 with instructions to scan for second wireless tracking device 24 and fourth wireless tracking device 28.

Second master communication device 14 receives first command signal 20, and sends second command signal 21 back to first master communication device 12 acknowledging receipt of instructions. Second master communication device 14 then begins scanning by transmitting locating signals 33 and receiving return signals 35, and locates second wireless tracking device 24 within second operating range 18. However, fourth wireless tracking device 28 is outside of second operating range 18, and cannot be detected by second master communication device 14. Second master communication device 14 sends a second command signal 21 to first master communication device 12 with an indication that second wireless tracking device 24 was located, but fourth wireless tracking device 28 was not. An alarm is then activated on at least one of the first and second master communication devices 12, 14 to alert the user that a particular article, in this case laptop 29 associated with wireless tracking device 28, is outside of the protective “force-field” and may have been lost or stolen.

System 10 then waits a predetermined time, such as 30 seconds, before repeating the scanning process looking for articles, although it should be understood that the duration of the waiting time can vary.

As shown, third wireless tracking device 26 is within both the first operating range 16 and the second operating range 18. Optionally, second master communication device 14 may scan for and locate third wireless tracking device 26 and notify first master communication device 12 that third wireless tracking device 26 was located.

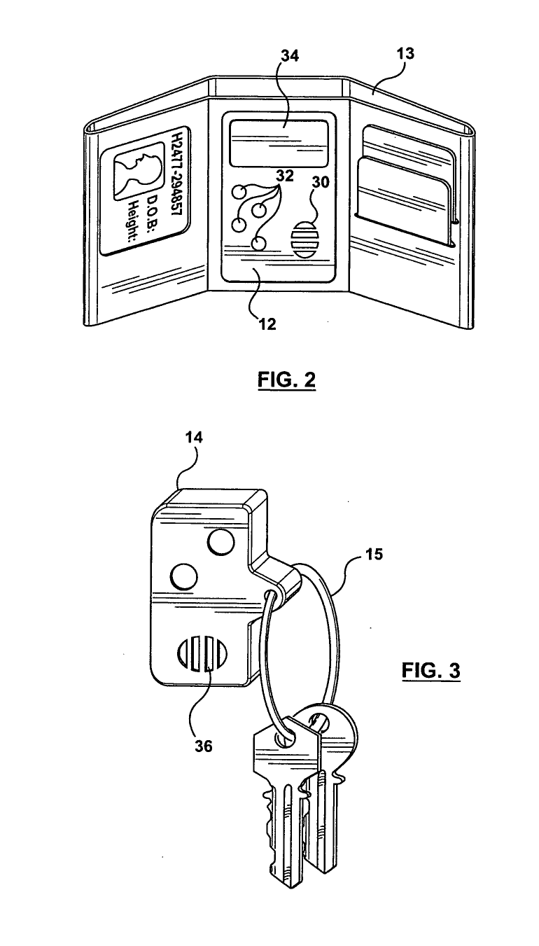

FIG. 2 shows first master communication device 12 inserted into a standard sized wallet 13. First master communication device 12 is sized and shaped to be inserted into wallet 13 such that wallet 13 can be worn or carried by a user without difficulty. Typically, first master communication device 12 is about the same height and width dimensions as a credit card, while being somewhat thicker. It should be understood, however, that first master communication device 12 could be sized and shaped to fit other types of personal articles.

First master communication device 12 preferably comprises an alarm 30, a small display screen 34, and input keys 32. Alarm 30 emits an audible tone of sufficient volume such that a user carrying wallet 13 would be able to hear the tone and be alerted to the fact that an article may have been lost or stolen. Alarm 30 could also vibrate or generate another signal notifying the user of an alarm condition. Input keys 32 may be used to program first master communication device 12, to manually scan for a particular article, to deactivate the alarm 30 once the user has been alerted, to individually activate and deactivate master communications devices 12, 14 and each of wireless tracking devices 22, 24, 26 and 28, and to perform other functions as required. Display 34 may provide the user with information about a particular alert, such as which wireless tracking device has gone missing, and which particular article that wireless tracking device was associated with. Display 34 may also be used to display information when programming first master communication device 12, and other information as required.

FIG. 3 shows second master communication device 14 affixed to a set of keys 15. Second master communication device 14 may be smaller than first master communication device 12, and may comprise less features. For example, as shown second master communication device 14 comprises an alarm 36, but no display screen or keys. It should be understood, however, that second master device 14 need not necessarily be subservient to first master device 12.

The system of the invention could utilize a variety of different technologies for communicating between the master communications devices and the tracking devices. One such technology utilizes passive ID tags and a tag reader/interrogator. The operation of the tags uses transformer theory in the near magnetic field. A transformer has a primary winding and a secondary winding, and the ratio between the number of turns of the two windings gives the ratio between the primary and secondary voltages.

In one embodiment, the antenna of the reader/interrogator acts as the primary winding of the transformer while the tag antenna acts as the secondary. Signal strength at the tag is proportional to the cube of the distance from the reader. When the reader is turned on, the tag powers up and transmit its ID data. The binary pulses modify the impedance of the tag's antenna, which in turn causes an amplitude shift in the reader signal. The inductance of the antenna and the resonant capacitor form a resonant circuit tuned to the operating frequency of the system. The tag transmits data by tuning and detuning the resonant frequency of this circuit. This process loads and unloads the secondary winding to reflect an impedance back into the primary. The result is an AM wave with a very low percentage modulation. This signal is peak detected and reshaped into a serial data signal which will be read and validated by the controller/processor.

Passive tags receive the RF signal from the reader and they rectify and filter this signal to provide DC power for the circuitry. This approach limits the reading distance available. Active tags have their own power source (battery) to boost the transmit power back to the reader/interrogator so they have a longer read range.

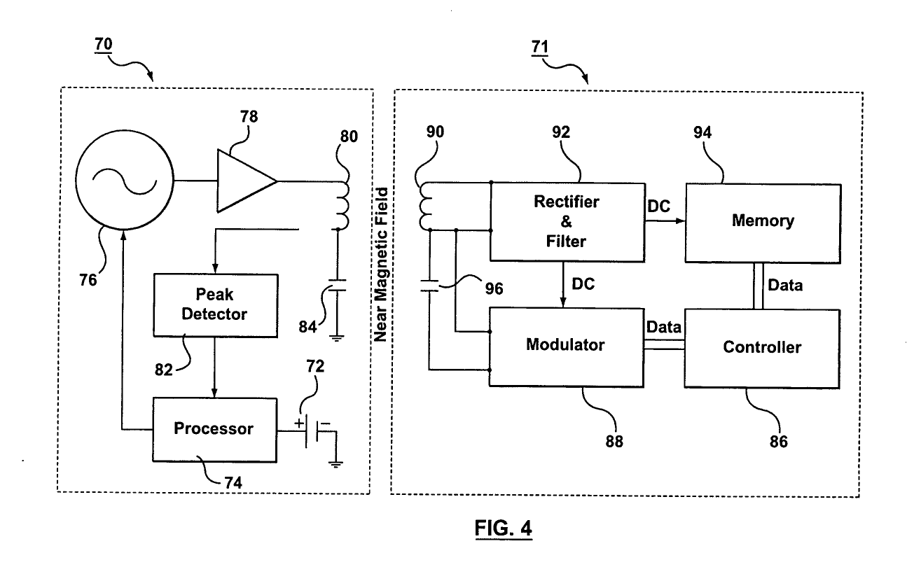

Referring now to FIG. 4, illustrated therein is an embodiment of the system of the present invention in which the master communication devices 12, 14 comprise a wireless transceiver module 70 in the form of a tag reader/interrogator, and each of the wireless tracking devices comprise a passive ID tag 71. Wireless transceiver module 70 is powered by a battery 72, connected to a processor 74 that controls the operation of transceiver module 70. Processor 74 may be a microcontroller or microprocessor. Transceiver module 70 further comprises an oscillator 76 for generating a time-varying signal, which is connected to a power amplifier 78 and then to an antenna 80, for generating a wireless signal, such as commands signals 20, 21 or locating signals 31, 35 for communicating with wireless tracking devices 22, 24, 26, 28. Antenna 80 is also connected to a peak detector 82 and to a resonating capacitor 84. Peak detector 82 detects the peaks of incoming wireless signals 35, 37 and provides controller 74 with a more valid reading of values. Processor 74 includes a memory (not shown) as necessary as will be understood by those skilled in the art.

Passive ID tag 71 comprises a controller 86, which may include a microcontroller or microprocessor, connected to a modulator 88 and a memory 94. Memory 94 can be used to store information about RFID tag 71, such as a unique identification number that is transmitted to transceiver module 70. Modulator 88 is further connected to a rectifier/filter 92, an antenna 90 and a resonating capacitor 96. Rectifier/filter 92 is also connected to memory 94.

During operation, when passive ID tag 71 is within the range of transceiver module 70 of first master communication device 12 or second master communication device 14, passive ID tag 71 is powered by the electromagnetic field which is generated by the operation of antenna 80 of transceiver module 70. The modulator 88 on the passive ID tag 22 modulates the incoming electromagnetic field in order to retrieve and transmit data to first transceiver module 70 using antenna 90. Rectifier/filter 92 operates to transform the incoming electromagnetic field, which generates an AC current, into a DC current which is used to power modulator 88, memory 94 and possibly controller 86. Controller 86 passes data back and forth between memory 94 and modulator 88.

Transceiver module 70 of master communication devices 12, 14 may be connected to input and output modules as desired, including but not limited to display screen 34, input keys 32, and alarm module 30.

By using a passive ID tag 71, wireless tracking devices 22, 24, 26, 28 can be made very small and lightweight, and there is no need to replace or recharge a separate power source.

Alternatively, wireless tracking devices 22, 24, 26, 28 could comprise active ID tags with an independent power source, instead of passive ID tags, which may be desirable when a larger operating range is preferred.

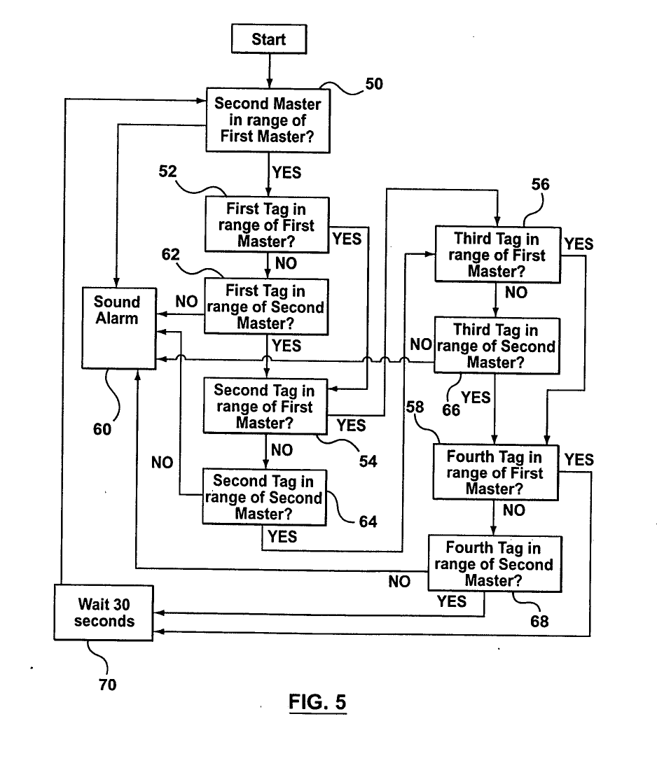

Referring now to FIG. 5, illustrated therein is a preferred embodiment of a method implemented by the system of the present invention.

At step 50, a determination is made whether the first and second master communication devices 12, 14 are within a predetermined master range of each other. If first and second master communication devices 12, 14 are within the range, the system can proceed to step 52. If first and second master communication devices 12, 14 are not within the range, the system proceeds to step 60, and the system generates an alarm notifying the user that there is a problem.

At step 52, the first master communication device looks for the presence of the first wireless tracking device 22 within a first operating range 16. If first wireless tracking device 22 is located, the system then proceeds to step 54. If first wireless tracking device 22 was not located, the system then proceeds to step 62.

At step 62, the second master communication device scans second operating range 18 for the presence of first wireless tracking device 22. If first wireless tracking device 22 is located, the system proceeds on to step 54. If second master communication device 14 does not locate first wireless tracking device 22, the system proceeds to step 60 where an alarm is triggered, notifying the user that there is a problem and an article may have been lost or stolen.

At step 54, first master communication device 12 scans to see if second wireless tracking device 24 is within its operating range 16. If the second wireless tracking device 24 is located, the system proceeds to step 56. If second wireless tracking device 24 is not located, the system proceeds to step 64.

At step 64, second master communication device 14 scans the second operating range 18 for the presence of second wireless tracking device 24. If second wireless tracking device 24 is located, the system proceeds on to step 56. If second master communication device 14 does not locate second wireless tracking device 24, the system proceeds to step 60 where an alarm is triggered.

At step 56, the first master communication device scans for third wireless tracking device 26 within its operating range 16. If third wireless tracking device 26 is located within its range, the system then proceeds to step 58. If third wireless tracking device 26 is not located, the system then proceeds to step 66.

At step 66, second master communication device 14 scans the second operating range for the presence of third wireless tracking device 26. If third wireless tracking device 26 is located, the system proceeds on to step 58. If second master communication device 14 does not locate third wireless tracking device 26, the system proceeds to step 60 where an alarm is triggered.

At step 58, first master communication device 12 scans for fourth wireless tracking device 28 within first operating range 16. If fourth wireless tracking device 28 is located, the system the proceeds to step 70. If fourth wireless tracking device 28 is not located, the system then proceeds to step 68.

At step 68, second master communication device 14 scans second operating range 18 for the presence of fourth wireless tracking device 28. If fourth wireless tracking device 28 is located, the system proceeds on to step 70. If second master communication device 14 does not locate the fourth wireless tracking device 28, the system proceeds to step 60 where an alarm is triggered.

At step 70, the system has successfully located all associated wireless tracking devices, and pauses for a predetermined time before repeating the scan. In a preferred embodiment, the predetermined time is 30 seconds.

Alternatively, first master communication device 12 could also scan for all wireless tracking devices within its range before instructing second master communication device 14 to scan for the wireless tracking devices that were not located by first master communication device 12.

The system of the present invention provides a user with a portable, dynamic system for actively preventing the loss and theft of personal articles carried by the user, without requiring active user intervention. As such, the system provides the user with a personal “force-field” against the loss and theft of articles.

The system of the present invention has a number of advantages over the prior art systems. The two master communications devices of the present invention provide a double force field that has a greater range than that provided by prior art systems having a single master communications device. The subject system is also more versatile than prior art systems, in that the double force field of the present invention varies in strength as the person moves the two master communications devices relative to each other.

While the preferred embodiment utilizes two master wireless communication devices, the present invention could utilize a third master wireless communication device. Also, one or more of the wireless tracking devices affixed to personal articles could operate as a master communication device. It should also be apparent that the system of the present invention is not limited to any particular number of wireless tracking devices, and that the system could be set up to enable the user to add and dynamically activate additional wireless tracking devices.

The system of the present invention could also be modified to enable the master communication devices associated with different people to all work together to provide a wireless peer-to-peer communication network In this system, even if a particular article is lost or stolen and is not immediately recovered by the user, the user will be alerted when the particular article is detected by another “friendly” device.

Accordingly, while the invention has been described with regard to preferred embodiments, it should be understood by persons skilled in the art that various modifications may be made thereto without departing from the present invention, the scope of which is defined in the claims appended hereto.

1. A system for monitoring the proximity of personal articles, comprising:
(a) at least one wireless tracking device affixable to at least one portable article to be monitored;
(b) a first portable master wireless communication device for communicating with the at least one tracking device and for determining when the at least one tracking device is outside of a first operating range;
(c) a second portable master wireless communication device for communicating with the at least one tracking device and for determining when the at least one tracking device is outside of a second operating range;
(d) the first master communication device and the second master communication device being operable to communicate with each other and to determine whether the first master communication device and the second master communication device are within a predetermined master range;
(e) wherein at least one of the first master communication device and the second master communication device is operable to generate an alarm if the second master communications and the second master communication device are not within the predetermined master range; and
(f) wherein at least one of the first master communication device and the second master communication device is operable to generate an alarm if the least one tracking device is outside of the first operating range and the second operating range.

2. The system defined in claim 1, wherein the first master communication device and the second master communication device are sized and shaped to be carried by the person in a pocket.

3. The system defined in claim 1, wherein:
(a) the first master communication device comprises a first wireless transceiver module for transmitting signals to and receiving signals from the second master communication device and the at least one tracking device;
(b) the second master communication device comprises a second wireless transceiver module for transmitting signals to and receiving signals from the first master communication device and the at least one tracking device; and
(c) the tracking device comprises a wireless transceiver for receiving the signals from and transmitting signals to the first master communication device and the second master communications device.

4. The system defined in claim 3, wherein the first master communication device comprises:
(a) a first processor for processing the signals from the second master communication device and for generating a first alarm signal if the second master communication device is not within the master range; and
(b) an alarm generating device for receiving the first alarm signal and for generating an audible alarm.

5. The system defined in claim 4, wherein the second master communication device comprises:
(a) a second processor for processing the signals from the tracking device and for generating a second alarm signal if the tracking device is outside the second operating range; and
(b) an alarm generating device for receiving the second alarm signal and for generating an audible alarm.

6. The system defined in claim 5, wherein the first processor is operable to process the signals from the at least one tracking device and to generate an activation signal activating the second master communication device if the at least one tracking device is outside the first operating range.

7. The system defined in claim 1, wherein the at least one tracking device comprises a plurality of tracking devices, wherein each of the plurality of tracking devices has a unique identification number.

8. The system defined in claim 3, wherein the first wireless transceiver module and the second wireless transceiver module comprise radio frequency transceivers.

9. The system defined in claim 8, wherein the at least one tracking device comprises a passive identification tag, and the wireless transceiver modules comprise tag readers/interrogators.

10. A system for monitoring the proximity of personal articles, comprising:
(a) at least one wireless tracking device affixable to at least one portable article to be monitored;
(b) a first portable master wireless communication device for communicating with the at least one tracking device;
(c) a second portable master wireless communication device for communicating with the at least one tracking device, the first master communication device and the second master communication device being operable to communicate with each other;
(d) the first master communication device being operable to determine whether the second master communication device is within a predetermined master range and to generate an alarm if the second master communication device is not within the master range;
(e) the first master communication device being operable to determine whether the at least one tracking device is outside of a first operating range and to prompt the second master communication device to communicate with the tracking device if the at least one tracking device is outside of the first operating range;
(f) the second master communication device being operable upon being prompted by the first master communication device to determine whether the at least one tracking device is outside of a second operating range and to generate an alarm if the tracking device is outside the second operating range.

11. A method for preventing the loss of portable personal articles, comprising the steps of:
(a) providing a user with a first portable master wireless communication device having a first operating range and a second portable master wireless communication device having a second operating range, the first master communication device and second master communication device being in wireless communication with each other;
(b) attaching at least one wireless tracking device to a portable personal article, the tracking device being in wireless communication with the first master communication device and the second master communications device;
(c) determining whether the first master communication device and the second master communication device are within a predetermined distance from each other and generating an alarm if the first master communication device and the second master communication device are not within the predetermined distance;
(d) sending a first locating signal from the first master communication device to the tracking device to determine a first distance between the first master communication device and the tracking device;
(e) generating an activation signal activating the second master communication device if the first distance is outside the first operating range;
(f) sending a second locating signal from the second master communication device to the tracking device to determine a second distance between the second master communication device and the tracking device; and
(g) generating an alarm if the second distance is outside the second operating range.

12. A method for preventing the loss of portable personal articles, comprising the steps of:
(a) providing a user with a first portable master communication device having a first range and a second portable master communication device having a second range, the first master communication device and second master communication device being in wireless communication with each other;
(b) attaching at least one tracking device to a portable personal article, the tracking device being in wireless communication with the first master communication device and the second master communications device;
(c) sending command signals between the first master communication device and the second master communication device to determine the distance between the first master communication device and the second master communication device;
(d) triggering an alarm on at least one of the first and second master communication devices if the distance between the first master communication device and the second master communication device exceeds a predetermined distance;
(e) sending a locating signal from the first master communication device to the at least one tracking device to determine the distance between the first master communication device and the at least one tracking device;
(f) if the distance between the first master communication device and the at least one tracking device exceeds a first operating range, sending a further command signal from the first master communication device to the second communication device, commanding the second master communication device to send a locating signal from the second master communication device to the at least one tracking device to determine the distance between the second master communication device and the at least one article;
(g) triggering an alarm on at least one of the first master communication and the second master communication devices if the distance between the second master communication device and the at least one tracking device exceeds a second operating range;
(h) if the distance between the second master communication device and the at least one tracking device is within the second operating range, waiting a predetermined time and then repeating the process.
